(19) United States
(12) Patent Application Publication
(10) Pub. No.: US 2013/0317886 A1
(43) Pub. Date: Nov. 28, 2013

(54) Customer Experience Management System Using Dynamic Three Dimensional Customer Mapping and Engagement Modeling

(71) Applicant: RAMYAM INTELLIGENCE LAB PVT. LTD, Bangalore (IN)

(72) Inventors: Lakkapragada Kiran, Bangalore (IN); Mantripragada Venkata Balasubrahmanyam, Bangalore (IN)

(73) Assignee: Ramyam Intelligence Lab Pvt. Ltd, Bangalore (IN)

(21) Appl. No.: 13/886,484

(22) Filed: May 3, 2013

(30) Foreign Application Priority Data
May 28, 2012 (IN) 2126/CHE/2012

(51) Int. Cl. G06Q 30/02

(52) U.S. Cl. CPC G06Q 30/0202
USPC 705/7.31

(57) ABSTRACT

A system and method that creates a real-time dynamic three dimensional customer profile for customers and enriches the dynamically created three dimensional customer profile, to deploy the next best actions (NBA) or best business actions (BBA) so as to enhance customer experience includes a linear transaction processing engine that acquires data from disparate sources to create a three dimensional customer profile for each customer, a data miner that provides different types of analytics based on correlation processing between the customer profiles and also maps the customer engagement modeling onto the dynamic three dimensional customer profile to apply the most relevant next best action and best business action for that customer and a policy designer layer that designs and launch programs based on the generated dynamic three dimensional customer profile and a presentation layer responsible for user interactions.

### CROSS-REFERENCE TO RELATED APPLICATIONS

This application claims priority from the Indian Provisional Application Number 2126/CHE/2012, entitled “Customer Experience Management System using Dynamic DNA Mapping and Engagement Modeling”, filed on May 28, 2012, the entirety of which is expressly incorporated herein by reference.

### FIELD OF THE INVENTION

The present invention relates to a customer experience management system. In particular the present invention relates to an improved approach to manage customer experience by mapping the customer's present context on to the organisational engagement using dynamic three dimensional customer mapping and engagement modelling.

### BACKGROUND

The service providers who have millions of customers and their daily customer transactions running into hundreds of millions find it difficult to engage a customer by understanding the context and requirements of each and every customer. This is true for customers who interact with the service providers for specific requirements and vice versa. Customer's present context is the ‘moment of truth’, which is the result of series of past experiences and the present interaction chain or the transaction mode they are into with the business.

Responsiveness to customer issues and needs has become increasingly important to most modern businesses. Majority of large customer driven organizations maintain a staff of customer service personnel. This staff may include troubleshooters who can provide technical guidance, logistic specialists who can identify why a product was not shipped on time or why a product did not arrive on time. Most of this support is based on the requests from the customer and not initiated by the service provider, understanding customer's present context. Currently there is no solution that provides the implementation of actionable best business practices to provide better customer interactions.

Hence, the customer support and service departments are typically dependent on the CRM (Customer Relationship Management) systems that allow service providers to respond from the situational transaction standpoint. Distinctive characteristics of those industries or organizations that face these problems include millions of customers, service oriented domains with post sale scenarios and automated customer service driven by contact centers. Therefore, currently there is no holistic solution that addresses customer engagement considering the customer's present context, previous transactions as well as the market dynamics for each and every customer. Also to implement effective actionable business method/process deployment model within the organization dynamically, to provide effective customer interactions for each and every customer.

For instance, the U.S. Pat. No. 7,379,880 describes a method of creating dynamic customer profiling for individual customer based on interaction and transaction data, but the document does not discuss clearly discuss about deploying effective business model for better customer interactions.

Similarly, U.S. Pat. No 7,698,163 describes a segmentation process that groups customers with similar characteristics into segments for targeting customers according to the likelihood of the customers to accept a particular marketing offer includes identifying and associating customers based on the following data such as customer behavior data (such as transaction information), contact history, customer value data, etc. but does not clearly discuss about deployment of business models/methods in the service providers side for better customer interactions.

In the view of the foregoing, there is an ongoing need for an improved system and method that can overcome these drawbacks and cater to the needs of variety of service providers including telecom service providers, banks, insurance companies, travel and leisure service providers, retailers and internet portals offering e-commerce facilities.

### SUMMARY

The present invention provides a system and method that creates dynamic three dimensional customer profile for each and every customer and deploys Next Best Actions (NBA) or Best Business Actions(BBA) on the generated three dimensional profile to enhance customer interaction. Examples embodiments of systems in accordance with the invention comprise a linear transaction processing engine (layer 1) to acquire data from disparate sources to create the dynamic three dimensional customer profile for each and every customer whereby the linear transaction processing engine acquires data from multiple discrete data sources to represent the three dimensional customer representative characteristics such as demographics, psychographics, social affinity; customer transaction profile representing customer events generated from the usage of services from the service providers, customer interaction profile representing the customer interaction with the service providers. A data miner (layer 2) provides various different types of analytics based on correlation processing between the customer profiles. The data miner of the present invention also maps the customer engagement modeling onto the dynamic three dimensional customer profile to apply the most relevant next best action and best business action for that customer. The system also has a policy designer layer (layer3) to design and launch programs based on the dynamic three dimensional customer profile generated by the transaction processing engine and enriched by the data miner and a presentation layer responsible for user interactions.

In accordance with example embodiments of the present invention, the linear transaction processing engine further comprises multiple nodes (such as a profile node, a transaction node, an interaction node, etc.) to create the dynamic three dimensional profile for each and every customer. Each node further comprises multiple modules such as acquisition, enrichment, normalization, IdeaT (intelligent decision and analytical tree (IdeaT) algorithm to manipulate and derive variable from the acquired, enriched and normalized fields using business logic), an outwriter component to update the data into the datamarts and an aggregator that adds similar records in each of the datamarts based on specific grouping rules. In accordance with an example embodiment of the invention, the system also allows the user to create multiple custom specific nodes depending on the business requirement to create dynamic three dimensional customer profiles for each and every customer.

In accordance with example embodiments of the invention, the data miner (layer 2) includes a set of logical processing engines such as a value scorer, association and linking, prediction modeling and engagement modeling for correlating customers based on their behavior. The value scorer of the data miner layer scores customer from various factors such as customer lifetime value, customer lifestyle segmentation, RFM values etc for each customer. The association and linking associates link customers with their families, friends, different lines of businesses, etc. Predictive modeling correlates customer behaviors and updates customer profiles with various predictive values. Engagement modeling correlates customer behavior and service provider interactions and transactions to provide higher success rate of customer interaction.

The system can be implemented on any operating system and use any database servers for storing millions of customer records that supports high reliability and scalability.

The method for creating a real time dynamic three dimensional profile for each and every customer and engaging the customer with next best actions and best business actions for further interaction comprises the steps of creating a dynamic three dimensional profile for each and every customer by acquiring data from various sources that represents customer characteristics (such as customer demographics, psychographics, social affinity), customer transactions using service provider's services and customer interaction with the service provider. Further, the profile is enriched by value scoring, engagement modeling, association and linking, predictive modeling and mapping the acquired and enriched customer profile onto the organization offerings to deliver the next best actions or best business actions to the customer through their relevant touch points.

The system also monitors the customer response and adds it back to the customer profile to provide real time dynamic customer feedback.

### BRIEF DESCRIPTION OF THE DRAWINGS

FIG. 1 is an example diagram of a network in which systems and methods consistent with the principles of the invention may be implemented.

FIG. 2 is an example architecture diagram of the computing devices that can be used as either client or server in which systems and methods consistent with the principles of the invention may be implemented.

FIG. 3 illustrates the dynamic generation of three-dimensional profile of the customer in accordance with an example embodiment of the invention.

FIG. 4 illustrates an example architecture model of the present invention in accordance with one or more example embodiments of the invention (for convenience, source systems in telecom are shown as examples).

FIG. 4(a) illustrates an example Node in accordance with an example embodiment of the invention (for convenience, source systems in telecom are shown as examples).

FIG. 4(b) illustrates the functioning of IdeaT in accordance with an example embodiment of the invention.

FIG. 5 depicts the functioning of a set of logical processing engines attached to the customer profiles to derive the correlation between the profiles according to an example embodiment of the invention.

FIG. 5(a) illustrates the various components of the logical processing engine in accordance with an example embodiment of the invention.

FIG. 6 illustrates the policy designer in accordance with an example embodiment of the invention.

FIG. 7 illustrates the customer experience business process in accordance with an example embodiment of the invention.

### DETAILED DESCRIPTION

The present invention overcomes the drawbacks of conventional systems and provides an improved approach to manage customer experience by mapping the customer's present context on to the organisational engagement using dynamic three dimensional customer profile mapping and engagement modelling. The present invention also provides a policy designer that enables the user to provide Next Best Action (NBA) or a Best Business Action (BBA) that can improve the experience of customers having similar problem areas.

In accordance with an example embodiment of the invention, the customer perceives experience from service providers through three different points such as touch points, non-touch points and impact points wherein the touch points are the primary contact points where the customer gets in touch with the business. The non-touch points are the points where customers perceive the experience indirectly as an effect of some business action within the organization. The impact points are actually the impact created on the customer experience due to the overall customer engagement with the business. In the context of this invention, the focus is on creating the superior customer experience by providing next best actions that affect the customer at the touch points and best business actions that affect the customers at the non-touch point level.

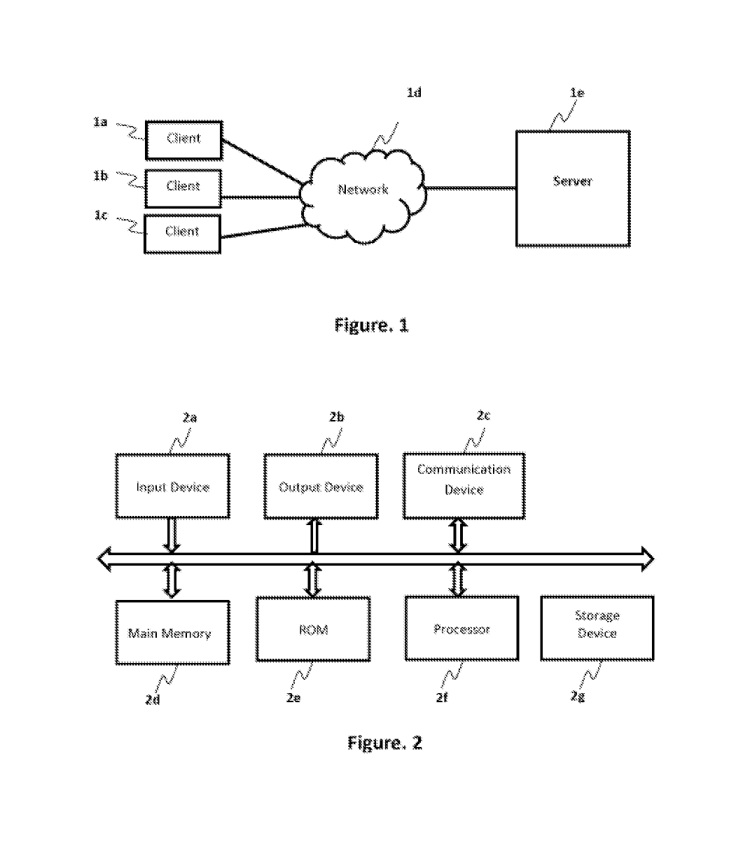

FIG. 1 is an example diagram of a network in which systems and methods consistent with the principles of the invention may be implemented. The network (1d) consists of several clients (1a-1c), where the software for customer experience management for creating real time dynamic three dimensional customer mapping and engagement modeling is configured. These clients (1a-1c) interact with server (1e) that executes the creation of dynamic three dimensional customer profiling for each and every customer and engagement modelling. The server (1e) executes the dynamic creation of three dimensional customer profile and engagement modelling by acquiring data from the CPD(Customer profile detailing) database.

The server (1e) comprises a linear transaction processing engine (layer 1, 201) to create the dynamic three dimensional profile for each and every customer, a data miner (layer 2, 202) to enrich the customer profile and a policy designer (layer 3, 203) to design and launch the next best action or best business action for each and every customer.

In practice, there will be more number of such servers and clients. The client (1e) may include any device such as a PC, laptop, mobile device, tablet or any other types of device that can support two way interactions with the user either using graphical user interface. In some cases, the client (1e) can be a software object or a program or a process or a thread of execution running on one or more of these devices.

In some cases all or part of the server configurations may be running on the client (1a-1c). In some cases, the client (1a-1c) may connect to multiple servers during the execution process. In some cases, the client (1a-1c) may perform the functions of server (1e) or server (1e) may perform client functions.

Network (1d) may include a local area network (LAN), a wide area network (WAN), a telephone network, such as the Public Switched Telephone Network (PSTN), an intranet, the Internet, a memory device, or a combination of networks. The network may be wired, wireless, optical, or any other information transmission mechanisms.

FIG. 2 is an example architecture diagram of the computing devices that can be used as either client or server. It includes input device (2a) to receive the inputs, output device (2b) to output the results of the processing, communication device (2c) for handling communication with other devices through network, main memory (2d) that holds the in-memory structures and instructions for the processing, ROM (2e) for the storage and retrieval read only static data, storage device that stores the instructions and data, and processor (2f) for processing the instructions. Bus is for the communication within the client or server and also may include mechanisms to connect to other client or server units.

Processor (2f) may include a standard processor, microprocessor or processing logic that interprets and executes instructions. Main memory (2d) may include a random access memory (RAM) or another type of dynamic storage device that may store information and instructions for execution by processor. ROM (2e) may include a conventional ROM device or another type of static storage device that may store static information and instructions for use by processor (2f). Storage device (2g) may include a magnetic/optical based recording medium and its corresponding drive.

Input device (2a) may include a conventional mechanism that permits a user to input information to the client/server entity, such as a keyboard, a mouse, stylus, voice recognition, biometric mechanisms, gesture recognition etc. Output device (2b) may include a conventional mechanism that outputs information to the user, including a display, speaker, etc. In some of the client implementations, input and output may be combined in a virtual characters that converse with the user in assisted search using speech recognition for the input and speech synthesis for the output and may be combined with video and/or animations. It is also possible that the input and output may be handled by another program or system, like in the case of a translator front-end tool which translates both input and output between the user and client/server entity. The software instructions may be read into memory from another computer-readable medium, such as data storage device, or from another device via communication interface. The software instructions contained in memory may cause processor to perform processes such as instructions for creating a dynamic three dimensional profile for each customer by acquiring data from various sources and updating the dynamic three dimensional profiles continuously to represents dynamic customer characteristics. Instructions for enriching the customer profile by value scoring the customer from various factors such as customer lifetime value, customer lifestyle segmentation, RFM values etc; associating and linking the customers with family, friends, different lines of business etc for correlating various customer profiles; updating the customer profile with various predictive values based on customer behaviors and providing an engagement modeling by correlating customer behavior and service provider interactions and transactions to provide higher success rate of interaction and delivering the next best actions (NBA) to the customer directly through their relevant touch points or deploying best business actions (BBA) to provide effective business workflow within a department or an organization for enhanced customer experience and monitoring the response and adding the response back to the customer profile to provide real-time dynamic customer feedback.

Alternatively, hardwired circuitry in an embedded system may be used in place of or in combination with software instructions to implement processes consistent with the principles of the invention. Thus, implementations consistent with the principles of the invention are not limited to any specific combination of hardware or software.

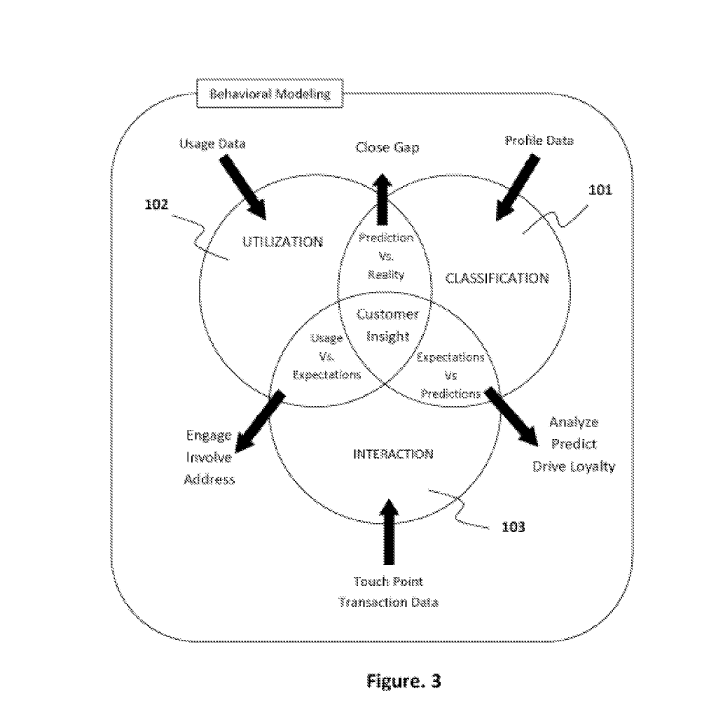

FIG. 3 illustrates the generation of three-dimensional profile of the customer according to one embodiment of the invention. The three dimension profile of the customer is created dynamically by a linear transaction processing engine. The three dimensions of the customer profile include customer representative characteristics from the profile data (101) (such as demographics, psychographics, social affinity), customer transaction profile (102) and customer interaction profile (103). Customer utilization/transaction profile (102) represents the service usage, conduct of the customer etc. Customer interaction profile (103) represents the customer interaction with the service providers. In order to profile the customer in these three dimensions, data from disparate data sources are captured and the customer profile data is enriched and inference is drawn using a high-end transaction processing engine guided by a set of classification algorithms. Since the customer engagement is a long term association of interactions and transactions for each and every customer, an engagement modelling is created based on customer long term interactions, transactions and profile data for each and every customer. A dynamic customer insight (three dimensional customer profiles) is developed initially and is updated dynamically based on the customer interactions for each and every customer. The engagement modelling is a process where the next best actions and best business actions are applied onto each customer with relevance and context clearly understanding customer's preferences (based on customer usage, predictions, customer loyalty etc) and experiences that are mapped on to the customer's current dynamic 3 dimensional profile. The three dimensional profile is created for each and every customer continuously and dynamically, in real time.

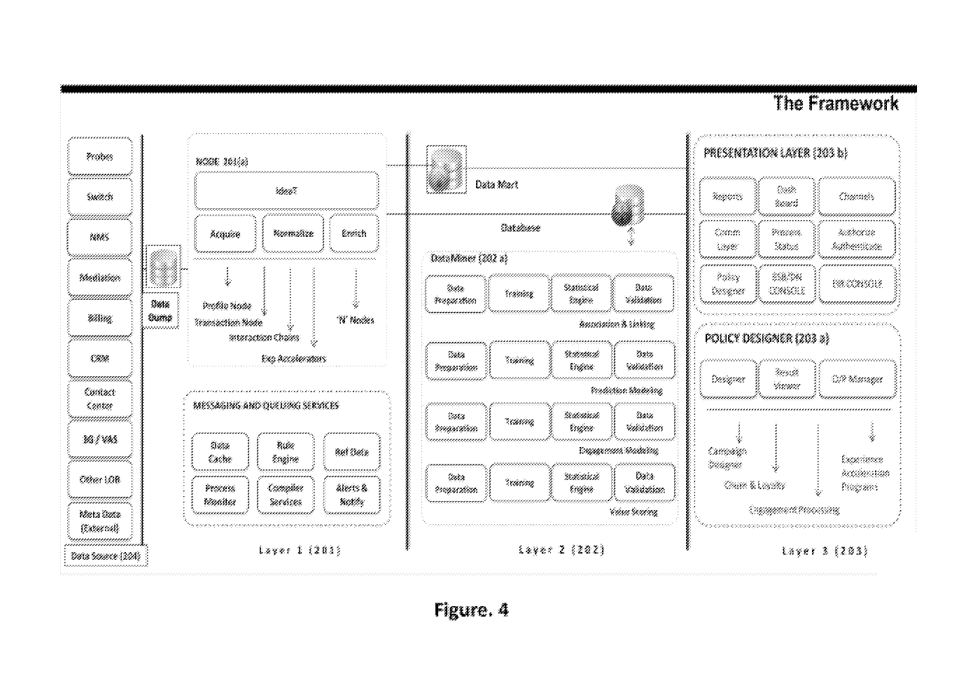

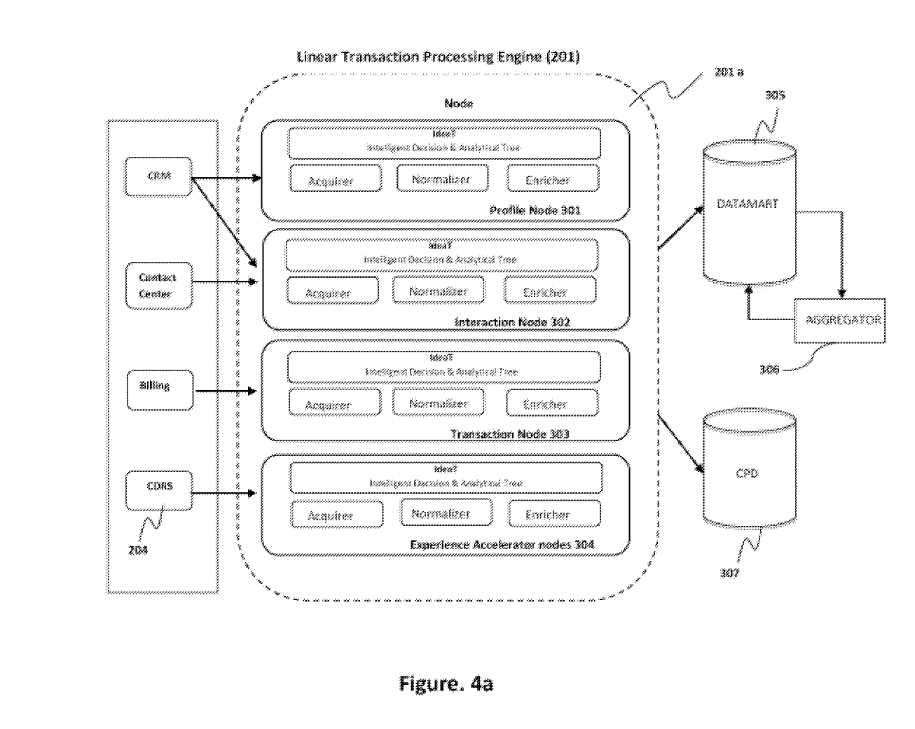

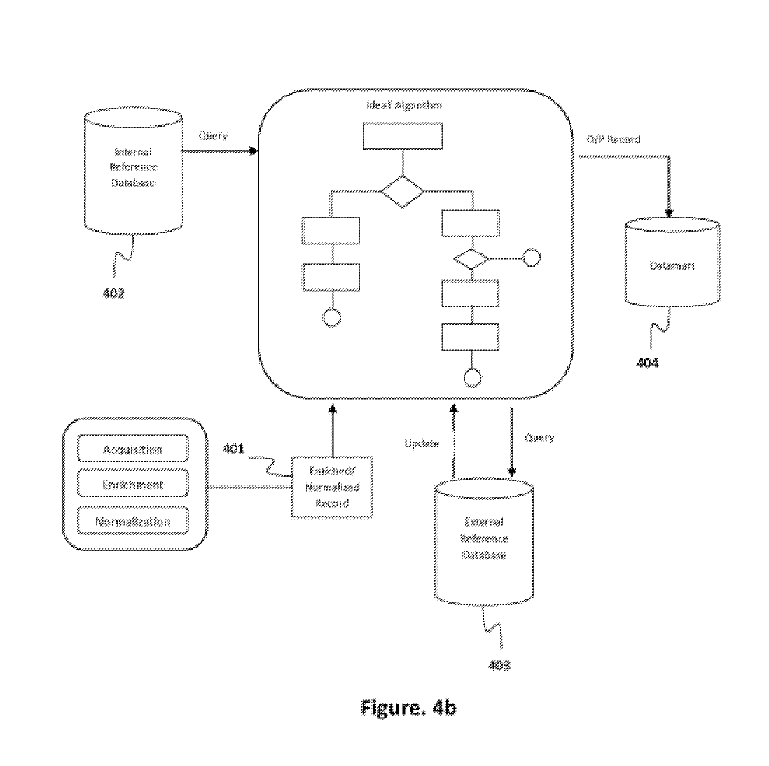

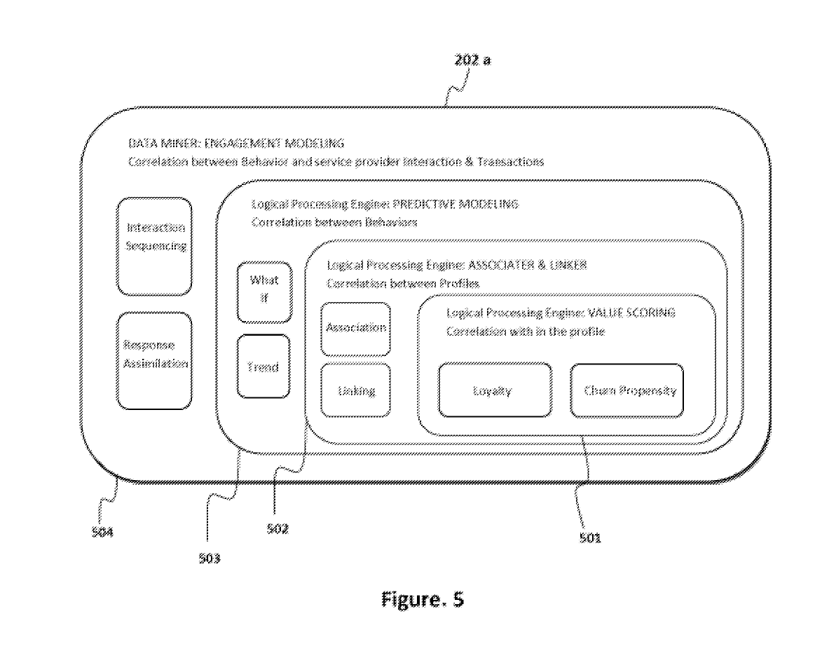

FIG. 4 illustrates the architecture model of the present invention from transaction processing standpoint where the application is deployed in a customer environment. Communication service provider (CSP) business is taken up as a reference point to explain the functional modules. As depicted in FIG. 4, the architecture model of the present invention consists of three layers of processing arrangement. Layer 1 (201) is a linear transaction processing engine that acquires data from disparate data source (204), cleanses and normalizes it as well as maintains the customer information to create the dynamic three dimensional profile of the customer. For this purpose, the layer 1 (201) includes node (201a) such as profile node, transaction node, interaction nodes, experience accelerators etc to acquire data from multiple sources (204) such as billing, contact centre to gather data regarding customer interaction, customer transaction etc. The engine primarily processes sequentially and classifies the customer from multiple different behavioural standpoints to create the dynamic three dimensional profile of the customer. Layer 2 (202) includes a data miner 202(a) that is responsible for mining the data based on the models that are prebuilt from customer experience standpoint. The data miner 202(a) of the present invention has various key correlational tools such as association and linking, prediction modeling, engagement modeling and value scoring etc. to provide correlation analytics between different customer profile. The data miner 202(a) of the present invention is also responsible for mapping the customer engagement on to the dynamic three dimensional customer profile to apply the most relevant “Next Best Action” or “Best Business Action” for that customer. The data miner also provides association and link analytics along with prediction models.

Layer 3 (203) includes a Policy Designer Layer (203a) that uses experience indicators to design and launch programs based on the dynamic customer profile created by the linear transaction processing engine (layer 1) and enriched by the data miner (layer 2). In this layer, on specifically defined Experience Indicators, users can define “Next Best Actions” as well as “Best Business Actions”. Policy Designer enables to design and launch programs such as Campaigns, Churn & Loyalty Management, Engagement Processing, Experience Acceleration Programs etc based on the customer profile data created and enriched by the linear transaction processing engine (layer 1) and modified by the data miner (layer 2). Furthermore, Presentation layer (203b) is the user interface that co-exists in layer 3 to ensure that the customer is available for configuration, transaction status management as well as output management including the reports and dashboard.

FIG. 4(a) illustrates the functionality of the linear transaction processing engine according to one or more embodiment of the invention. The functionality of the linear transaction processing engine (201 as shown in FIG. 4) is achieved using a sequential processing engine called a node ((201a) as shown in FIG. 4). Depending on the requirement of the customer, multiple nodes are created to acquire data from one or more data sources as required whereas, each node has a specific objective of mapping a specific set of source data from the service provider on any of the two dimensions. In particular, three nodes (profile node 301, transaction node 302 and interaction node 303) are mandatory for creating the dynamic multi dimensional profile of each and every customer. Besides, depending on the data sources (204) and the way the data is organized, some of the requirements may be realized using multiple nodes under the same realm. Occasionally, it may be required that a specific mapping of only few parameters is done, from profile, transaction and interaction, to derive a specific understanding of the customer profile. Based on this understanding the businesses would focus their actions on specific area of customer experience. This is achieved using a custom specific node and is called as an Experience Accelerator (304).

The following section explains different components within the node (201a) and how different nodes are built to dynamically create the 3 dimensional profile of every customer and also the creation of experience accelerators (custom specific nodes). Each node (201a) is an independent sequential processing chain acquiring data from one or more data sources (204) for deriving and correlating information for a single customer. The nodes are also responsible for incrementally creating datamart (305) from the derived as well as from the primary information. While the information related to each customer is updated from different nodes to generate dynamic three dimensions of the customer and is captured in a CPD database (307), the primary and derived attributes are updated to generate intelligence in the datamart (305).

Components of Node:

In addition each node (201a) has various configurable components such as acquirer, enricher, normalizer, IdeaT, outwriter and aggregator. The following subsections explain each of the components in the context of Profile Node (301).

Acquirer:

Acquirer is the module within each node (such as Profile Node (301), Interaction Node (302), Transaction Node (303), etc.) that is capable of picking up data from multiple data sources (204) in which the location of the data source, format of the data source and type of data source as well as access mechanism to the data source is fully configurable. Location of the data source may be local, remote or shared folder. Format of the data source can be in the form of files having records with separators, headers, compressed forms etc. Further the type of data source used may be files, pipes or databases and access mechanism employed for the data source may be through any secured connection, using login and password details, IP address and port numbers. Furthermore, each acquisition is the starting point of a unique node and is identified with a unique ID. The acquisition can be triggered using scheduling mechanism or from an event (for e.g., acquire as soon as a file of specific type is available or a record is updated in a database). Acquisition is also a module where the procedure to read each record and the fields with in the record are configured. These fields are called “Native Fields”. Each of the native field is named and throughout the downstream modules in the node, these native fields are identified using these configured names provided in the acquisition module.

Enricher:

Enricher is the next module in node, wherein each of the fields with in the record is treated using a rule. The enriched fields are stored as additional fields generated by configuration along with already existing native fields from Acquisition. The rules that can be applied by these fields are regulated by a specific syntax called “LDML” —Logical Data Manipulation Language. The syntax contains different type of arithmetic, logical functions that can be applied on the original fields.

Normalizer:

Normalizer is the next module that normalizes data acquired from data sources of same type but have a change in the format, so that from a business logic perspective there is no difference in the downstream components and database. The normalization is best illustrated by the following example. For instance, in a communication service provider's network, if there are two network elements from different vendors generating call detailed records (CDRs), such as Nokia-Siemens and Ericsson and both generate CDRs in different formats. In such scenarios the downstream component or business logic focuses on the type of calls made by the customer and not the different formats of the CDRs'. To explain further, the calling number in the first format may be 20th field having 25 characters with filler characters as “f” and the calling number in the second format may be 13th field having 16 characters with no filler characters but filled with space. In the first case, the enrichment module will trim the “f”, the second case will have the space trimmed. Both the native calling numbers are then moved to a single normalized variable called “call originating number”. Just like the enrichment, the normalization module is configurable and normalized variables can be defined as required for the downstream business logic configuration.

FIG. 4(b) illustrates the detailed functioning of Intelligent Decision and Analytical Tree (IdeaT) component of the node where the business logic resides. IdeaT is the component within the node where the business logic resides. The business logic is mainly directed towards creating derived variables from the native and enriched/normalized record (401). The business logic is written using a specific algorithm and uses a specific syntax called PDML Procedural Data Manipulation Language (PDML). The business logic also takes help of reference data to build the logic as well as derive the variables. The reference data is of two types—internal data and external data. The internal reference database (402) resides in the memory and follows a specific format. The internal reference data can be a simple look up table list; it can also be a range or short codes. As apparent, the internal reference data is faster to access and more static in nature. For example, the internal reference data can also be the list containing all the international dialling codes and associated countries, so the business logic will fetch the normalized “call originating number”, do an incremental match with the list containing the long distance (country) codes and fetches the calling number's origination country.

The external reference database (403) is not restricted by any format. This external reference data is accessible by the analytical tree to manipulate and derive data. The external reference tables may be updated using an outside routine or it can be also be updated by another node. The external reference data can be both queried as well as updated; however, the internal reference data can only be queried. In accordance with the present invention, the extended reference data is always the dynamic three dimensional profile of the customer.

The Intelligent Decision &Analytical Tree (IdeaT) as depicted in FIG. 4(b) are predefined IdeaTs that are configurable as per the requirement in accordance to one embodiment of the invention and in accordance to another embodiment of the invention, custom IdeaTs can also be developed without any changes to the core source code. But the newly created custom IdeaTs also requires the creation of new front end UI, as there is a defined template of User Interface (UI) for each of predefined IdeaTs.

Outwriter:

The Outwriter component of node (not shown) is responsible for updating the data into the Datamart tables as per the configuration. Unlike updating the Customer Profile database, the Datamart tables are inserted with a complete output record from the node's IdeaT. The datamart tables cannot be updated from different nodes. It is possible to configure specific fields from the output record that needs to be updated into the Datamart table with in the Outwriter component.

Aggregator:

Aggregator (306) is the module that works on each of the Datamart tables to add up the similar records based on specific grouping rules. The working of the aggregator module is similar to a “group by” in SQL on large set of parameters. The aggregation can be scheduled as required on each of the datamart tables. Furthermore, the aggregation can be scheduled on previously aggregated datamart tables.

Node Configuration for Creation of Dynamic Three Dimensional Customer Profile:

The following section elaborates on how different nodes contribute for the creation and enrichment of the dynamic three dimensional customer profiles according to one or more embodiments of the invention. Initially the primary three dimensional profile of every customer is created by the three mandatory nodes such as Profile, transaction and interaction which later update the CPD database (307). The primary three dimensional customer profile created by the above process is further enriched by sub nodes or the custom specific nodes.

The primary functionality of the profile node is to update the customer derived profile and the primary data source for the profile CRM system. Profile node further comprises customer derived profile, demographics and service subscription. In addition the Profile node also updates the transaction tables such as demographics, profile & usage, profile churn, loyalty score and profile usage.

Similarly, the primary functionality of the transaction node is to update the service usage behaviour of the customer and the transaction node uses the billing system as the primary data source for the same. The transaction node updates the transaction tables such as service usage behaviour, price plan mapping, RFM (Recency, Frequency and Monetary) analysis, price plan mapping, transaction churn and loyalty score.

Multiple Sub Nodes:

In one or more embodiment of the invention, multiple sub nodes of transaction node are created to enrich the dynamic three dimensional profile of the customer. The following example illustrates the other additional multiple sub nodes used other than the three primary mandatory nodes for communication service providers. The various other sub nodes created for communication service providers include bill shock, device intelligence, watch dog and so on.

Bill shock is an illustrative custom specific node created to update the bill related shocks and difficulties of the individual customers. Based on specific CDR input files such as data sources, Bill shock threshold is verified either in real time or in batch processing mode to calculate and update the shocks of individual customers related to usage. Moreover, custom specific nodes such as device intelligence and watch dog are also created. The device intelligence node updates the customer device table with various devices related parameters to understand the customer preferences related to devices using call detail record (CDR) input files as data sources. The three dimensional customer profiles are updated when the device profile of the customer is changed. Similarly, watch dog takes specific CDR input files as well as network logs such as data sources, customer experience and QoS (Quality of Service) related to network and updates the customer database related to network and service experience.

The interaction node (302) updates the interaction behaviour of the customer. The primary data source (204) for the interaction node is contact centre or the CRM database wherein the data picked up is related to the payment behaviour, service requests, complaints, disputes as well as feedback. The interaction node (302) analyzes the payment behaviour, service requests, complaints and disputes, as well as feedback to update various tables such as payment behaviour, customer interaction behaviour, loyalty and churn index based on the resolution effectiveness. Similar to transaction node (303), interaction node (302) also has sub nodes depending on the native data sources and the way the data is organized.

The sub nodes also include issue resolute node and response model node. Issue resolute node tracks each of the interactions specifically with respect to the service requests against the service level agreements (SLAs) for the service. The unresolved issues and the ones failed the SLAs are updated to the subscriber profile as well as the transaction tables. Hence the customer profile tables updated are issue resolute and churn and loyalty index. In response model node each of the customer fronting programs created by the CEM data miner is tracked by special node called “Response Model Node”. The response model node further updates both the customer profile tables as well as the transaction tables highlighting the response behaviour of the customer from the various factors such as campaigns, offers or promotions, churn propensity, loyalty meter and behavioural change to the engagement map.

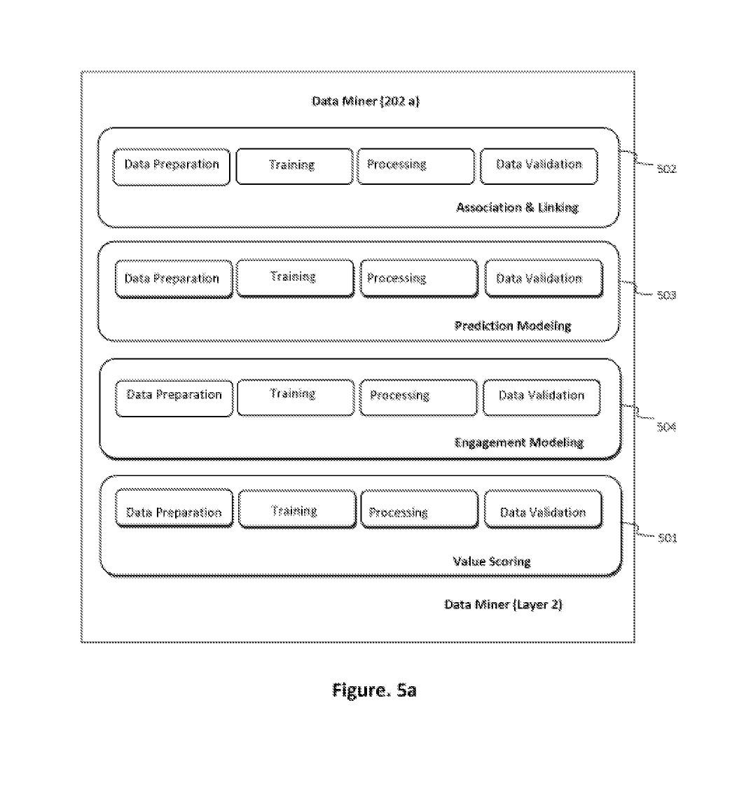

FIG. 5 depicts the functioning of a set of logical processing engines attached to the customer profiles to derive the correlation between the profiles according to one embodiment of the invention. Data miner (layer 2) (202a) of the architecture model has a set of logical processing engines that run on the customer profile to derive correlation inference between the profiles. Specific logical processing engines work on the customer profile to correlate various attributes within the profile and with other customer profiles and activities.

The Specific logical processing engines are asynchronous processes that work on the customer profiles to generate correlation analytics. The data miner (layer 2) (202a) caters to four types of correlation analytics. The key correlation tools provided are value scoring (501), association and linking (502), predictive modelling (503) and engagement modelling (504). Further each logical processing engine has key functional goals from correlation analysis standpoint. Data attributes of each customer enriched by each logical processing engine also becomes additional attribute for analytical processing by next higher logical processing engine. Apart from the specific analytics, set of predictive modelling logical processing engines shall be made available as part of the data miner (layer 2) (202), that runs on the customer profiles to create comprehensive prediction and trending.

Further, each logical processing engine has different components for processing as depicted in FIG. 5(a). Each logical processing engine of the data miner (202a) model, such as value scoring 501, association and linking (502), prediction modeling (503) and engagement modeling (504) comprises different components such as data preparation, training, process engine or statistical engine and data validation for processing. Though the naming of the components is similar to each of the logical processing engine, the inherent logic within the components is completely different from each other.

Value scoring (501) is a logical processing engine that correlates attributes within the customer profile. The prime functionality of the value scoring is to score the customer from loyalty and churn propensity standpoint. The scoring is also done based on various factors including derived values from the customer lifetime value (CLV), customer lifestyle segmentation (CLS) and RFM values for each customer.

Association and Linking (502) provide correlations between the customer profiles. Association associates customers with their friends, family as well as updates any missing information from external data sources such as credit rating agencies, government census or social security programs as well as from the social media. This enables the service provides to organize better management of the campaigns and programs that can be bundled to targeted groups. Linker links customers from different lines of business as well as from different product groups. This enables the service provider to understand the customer activity from multiple service and product usage stand point, create offers, campaigns that can cross sell, understand the customer propensity and behaviour for various products and requirements.

Prediction modeling (503) correlates customer behaviours and provides statistical models that update the customer profiles with various prediction values. These allow the subsequent policy designer to analyze “what if” scenarios as well as “Trend Prediction” with respect to each of the customers.

Engagement modeling (504) correlates the customer behaviour and service provider interactions & transactions so that better policies can be formulated with higher success rate for the nature of the interactions. Logical processing engine for Engagement Modeling continuously updates customer profile by correlating the customer behaviour with service provider transaction and interaction and provides the various insights such as how the interactions have to be sequenced and how the customer response behaviour has to be analyzed and how this need to be followed up. The output from the customer profile is updated in the form of engagement map to the customer profile. The downstream policy designer (203a) in layer 3 (203) integrates with the touch points and provides engagement modelling based on the engagement map created by the logical processing engine.

FIG. 5a depicts the sub-modules such as data preparation, training, processing engine and data validation present within each logical processing engine (such as value scoring (501), association and linking (502), prediction modelling (503) and engagement modelling (504)) for processing according to one embodiment of the invention. Data preparation is a process where the customer profile data is arranged and in some cases updated for the configuration team to be able to derive rules and processes as per the module. Data preparation changes from module to module and domain to domain. For example, the value scoring sub-module updates the customer profile with his RFM, response index, payment re-charge behavior, service subscriptions, ageing within the network etc, where as the association and linking module requires customer profile to be updated with counters consisting of the customer's made and received calls. Training is the process of identifying the rules by correlating the data manually on the customer profile. This is generally taken up after the data is prepared for the specific module. This module is very prominent, as the configuration analyst will not be having data in advance to analyze or frame the rules. The rules are to be derived at by looking at the data and correlating the business rules that can be configured. Processing engine is the sub module that processes each of the customer data as per the rules configured in the training module. The processing engine enriches the customer profile data as per the context of the module. For e.g., scoring module updates the customer profile with the customer's life cycle state, value, loyalty index, response index etc., while linking module links customers with other lines of business. Data validation is a process of verifying the data processed by the processing engine. The data is validated based on the number of best-case matches/rules processed by the processing engine. Sometimes the data is validated by asking customer, in this case whether the data access is provided to the customer at their preferred touch points.

The sub-modules of the logical processing engine according to one embodiment of the invention are best explained by taking association and linking with a telecom service provider's business case as an example. In the context of telecom service provider, association connects the subscriber of a telecom service provider with other subscribers and linking links a subscriber of one service with other services the subscriber is using, from other lines of business. During the data preparation phase of association and linking, the customer profiles are tagged with high frequency callers and subscribed called numbers using counters. An algorithm is written to tag each subscriber with top callers and called numbers. These counters are updated with periodic historical CDRs of at least 6 months to identify consistency in the behavior of customer calling and receiving pattern. From the counters, it is required to associate the subscriber with other subscribers using common factors and eliminate counters which are incidental and only for a fixed period of time. For e.g., a customer may be associated to another customer having the same common name, same address, same business address, both the profiles went to same school or worked in the organization which can be derived from their social profiles. The GUI of data miner provides a visual mechanism for configuring rules by actually associating and linking customers to other customers as well as other lines of business by actually working on sample data. This is called configuring rules for training the data miner. Once data is prepared and engine is trained, the logical processing engine processes each and every profile for the configured rules to create associations with other customers. For e.g, if there are one million customer profiles, the processing engine processes all the one million profiles for the configured rules. During processing, the processing engine attaches each profile with best possible matches. After the completion of processing, the data needs to be validated as it is essentially created by a combination of rules derived during training. The data validation is conducted using two mechanisms namely customer validation and best-case validation. The associated and linked data is presented to the customer at suitable touch point like a kiosk, self care or even an email, for customer to validate the data. Once customer validates the data, it can be stored in the database, so suitable promotions, custom tailored campaigns to the groups based on the profile, cross sell or even group bundled offers can be provided. Similarly once the customer agrees and identifies himself across the lines of business; it is easy for the business to provide cross campaigns and promotions. Loyalty and discounts across products and services. The drawback in this approach is that not all the customers may take time to approve the associations and linking created by EIR or may not approve the connections during the life cycle engagement of the relationship. In this scenario the best case validation approach is undertaken. In the best-case validation approach, the data miner can constitute the best case matches for association and linking and least case matches based on the number of constraints used to associate with other customers and LOBs. This will enable the service providers to fix specific cross sells, friends and family based discounts and loyalty bonuses in best case matches where as generic offers and privileges for least case matches till the customers validate the data created by the data miner engine.

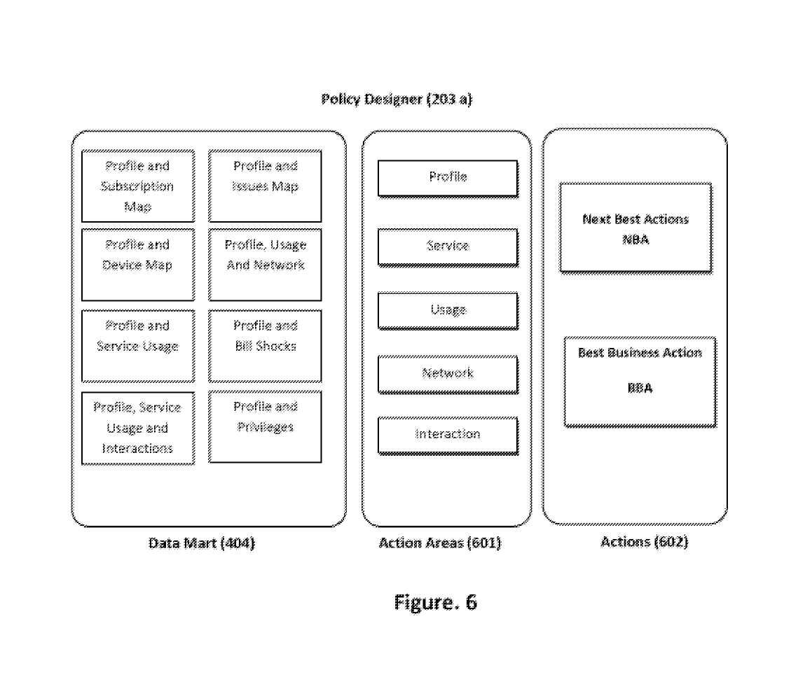

FIG. 6 illustrates the Policy Designer (203a) (layer 3) of the architecture model according to one embodiment of the invention. The Policy Designer (203a) enables the user to create and apply specific policies to manage and govern the customer experience. The Policy Designer (203a) also provides a graphical user interface where the user can define action areas and specify what can be a Next Best Action (NBA) or a Best Business Action (BBA) that can improve the experience of customers having similar problem areas. The data mart (404) (as shown in FIG. 6) created from different nodes forms the basis to understand the customer experience status experienced by different custom groups generated from the data. Further the data from the data marts is presented to the end user in the form of experience indicators set against the conditions configured in the policy designer. The extracted experience indicators are arranged under different Action Areas (601). The service providers understand the status of the experience indicators under the set action areas and apply Actions (602) to improve the experience.

Depending on the context of the service provider's business, several areas to improve the customer experience can be arrived at. In some cases, these areas can also be segregated based on the way the different business functions within the service provider's business are organized typically as departments. For instance, various Action areas (601) are identified in the context of telecom service providers such as profile, service, usage, network and interaction. For each of the Action Area, specific Experience Indicator and associated performance indicators are arrived based on the mapping created at the Data Mart (404) level by the Architecture Layer 1, node. Further each Action Area (601) is mapped on to one or more nodes. The Experience Indicator and associated Performance Indicators are basically customer experience constraints set on the Data Marts created from specific nodes that are part of an Action Area (601).

Accordingly, the policy designer provides a business rule configuration where actions (602) such as Next Best Actions are defined and attached to specific Action Areas. NBAs are set of actions that are applied on the customer at various touch points that can directly lead to improvement of experience and aspires to move the customer into the next level of engagement. NBAs belong to a category or department of the service provider's business and include campaign, promotion, communication, information, reward and discount. Hence, depending on the business model of the service provider, the framework can be customized to create custom specific NBA types for a business and map them to a category and department. Once these NBAs are defined and associated to a particular type, category and department of the business, the filter automatically attaches the NBA to a specific Action Area and associated Experience Indicators.

In accordance to one or more embodiment of the invention, the policy designer also provides actions (602) such as Best Business Actions to provide effective business workflow within a department or an organization for enhanced customer experience. The policy designer provide a workflow component where the user can specify workflow rules to manage the Non-touch point actions that can directly impact customer experience. Best Business Actions are internal actions taken up by the business firm for better customer interactions. These actions are not direct but indirect actions towards the customers at the touch points. The owner of the CEM Program or the CEM Department defines the workflow Like a typical workflow with in an enterprise, a BBA can constitute multiple tasks each may be completed by different departments. The workflow shall also contain hierarchy for escalation in case the task is not completed in stipulated time. The workflow can also be branched in case of exceptions when some of the tasks cannot be completed for various reasons.

At any point of time, the status of the BBA is track-able and CEM owner can visualize the impact of the BBA on various customer segments affected by the same problem. A Best Business Action may involve multiple departments and teams. The BBA is provided as part of the Policy Designer in a workflow.

BBA is set up as set of related tasks that are track-able and have their own SLAs beyond which can be escalated within the departments to complete the tasks. There are three types of BBAs which includes work flow, product creation and effectiveness measurement. Further each BBA comprises of various attributes and is defined using the policy designer. The attributes comprises of different set of tasks wherein each task comprises definition, timeline, role of the person to act and team member. BBA also further comprises attributes such as escalation and data source where further data source includes experience indicators and response indicators.

In accordance to one embodiment of the invention, the implementation of BBA is explained in the context of Telecom Service provider environment where the service provider receives a lot of complaints due to frequent call drops in a particular area. In this type of scenarios, the telecom service providers cannot do anything directly to the customers through touch points. Instead, the telecom service provider creates workflow for managing call drops by installing a cell phone tower in that particular area to decrease the call drops and also to enhance customer experience.

Workflow creation involves the integration of various departments and allocation of tasks to various individuals in each department. Considering the telecom service provider it involves the integration of financial department (to approve the budget), followed by the logistics and procurement department to scout the physical location to deploy the cell phone tower, civil works to be done by the civil department and a networking team to carry out the network integration. The CEM owner creates a set of tasks to be assigned to individual departments (such as Financial, logistic and procurement, civil, networking etc) and the created process is also tracked as a part of Best Business Action workflow. The BBA created using the above approach indirectly enhances the customer experience by reducing the number of call drops at the same time. As highlighted, the BBA tasks are not carried out at the touch points unlike an NBA.

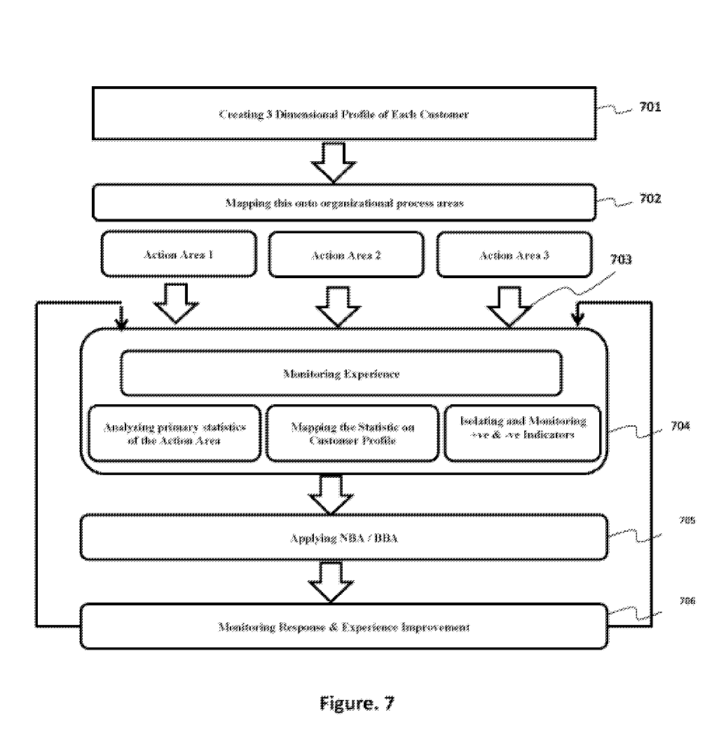

FIG. 7 illustrates the management of customer experience as a business process in accordance to one embodiment of the invention. The customer experience business process is initiated by creating a real time dynamic three dimensional profile of each and every customer by acquiring data from multiple data sources (using customer representative characteristics such as demographics, psychographics, social affinity, customer transaction profile, customer interaction profile) and updating it continuously to provide dynamic three dimensional profile of the customer as in step 701 and enriching the customer profile by Value scoring, Engagement modeling, Association and linking & Predictive modeling of the customers and mapping the enriched customer profile onto organizational offerings in step 702. Under each action area analyzing the primary statistics such as performance indicators, mapping the customer profile onto each of these statistic areas and monitoring the experience to identify the positive and negative experiences in step 704. Applying the next best actions or best business actions in step 705, once the performance indicators, profile indicators and positive and negative experience indicators are identified, delivering the next best actions directly to the end customer through their relevant touch point or deploying the Best Business Actions workflow model within the enterprise/departments to create a workflow model to solve the customer needs indirectly. Monitoring the response and experience improvement in step 706 and mapping the same to the experience of each customer to provide output of the response back to the Action areas.

The above cycle of customer experience is effectively and dynamically managed at all stages of the customer lifecycle, as a business process. Therefore, the present invention provides a process to manage the customer experience by creating a three dimensional profile of each and every customer leading to the dynamic three dimensional customer profile and mapping these dynamic profiles onto organizational offerings for creating next best actions and best business actions to finally delivery the experience to the customer with relevance context as per the engagement modelling.

What is claimed:

1. A system for creating a real-time dynamic three dimensional customer profile for customers and enriching the dynamically created three dimensional customer profile, and to deploy next best actions (NBA) or best business actions (BBA) so as to enhance customer experience, the system comprising:
(a) a linear transaction processing engine to acquire data from disparate sources and update the data continuously to create a dynamic three dimensional customer profile for each customer;
(b) a data miner to enrich the customer profile by providing a plurality of analytics based on correlation between customer profiles, wherein the data miner maps the customer engagement modeling onto the created dynamic three dimensional customer profile to apply the most relevant action areas such as next best action or best business action for that customer;
(c) a policy designer layer including a graphical user interface for designing and launching a plurality of action areas comprising at least one of next best action and best business action for a customer based on the engagement modeling, wherein:
(i) the next best actions are actions that are applied to the customer directly for better customer interaction, and
(ii) the best business actions are actions that are deployed to the business firm for better customer interaction; and
(d) a presentation layer responsible for user interactions.

2. The system of claim 1, wherein the created dynamic three dimensional customer profile for each customer comprises customer representative characteristics including at least one of demographics, psychographics, social affinity, customer transaction profile, customer interaction profile, and representing the customer interaction with the service providers.

3. The system of claim 1, wherein the linear transaction processing engine further comprises multiple nodes for creating the dynamic three dimensional profile for each customer.

4. The system of claim 3, wherein each node further comprises:
(a) an acquisition module to pick up data from multiple data sources to represent customer characteristics;
(b) an enrichment module including rules to apply to the data obtained in the acquisition module;
(c) a normalization module to normalize data acquired from data sources of the same type but different format;
(d) an intelligent decision and analytical tree (IdeaT) algorithm to manipulate and derive a variable from the acquired, enriched and normalized fields using business logic;
(e) an outwriter component to update the data into a datamart table; and
(f) an aggregator to add similar records in the datamart table based on specific grouping rules.

5. The system of claim 4, wherein the IdeaT is written using a specific algorithm for deriving the variable from the acquired, enriched and normalized fields.

6. The system of claim 3, wherein the system uses three primary nodes comprising a profile node, a transaction node and an interaction node for creation of the primary dynamic three dimensional customer profile for each and every customer.

7. The system of claim 6, wherein the system also allows a user to create multiple custom specific nodes depending on a business requirement to further enrich the dynamic three dimensional customer profile for each customer apart from the three primary nodes.

8. The system of claim 1, wherein the data miner includes a set of logical processing engines that run on each customer profile to derive a correlation inference between customer profiles.

9. The system of claim 8, wherein the processing engines include key correlation tools, the key correlation tools comprising:
(a) a value scorer to score each customer based upon factors comprising at least one of a customer lifetime value, a customer lifestyle segmentation, and RFM values for each customer;
(b) association and linking to associate and link customers with family, friends, and different lines of business;
(c) prediction modeling to correlate customer behaviors and update customer profiles with a plurality of predictive values; and
(d) engagement modeling to correlate customer behavior and service provider interactions and transactions so as to provide a higher success rate of interaction.

10. The system of claim 1, wherein the policy designer provides a graphical user interface for a user to select action areas from a list of different action areas, derived from a plurality of customer nodes for each customer to enhance customer experience.

11. A computer-readable medium containing computer-executable instructions for creating a real-time dynamic three dimensional customer profile for customers and enriching the dynamically created three dimensional customer profile, and to deploy next best actions (NBA) or best business actions (BBA) so as to enhance customer experience, the instructions comprising:
(a) instructions for creating a dynamic three dimensional profile for each customer by acquiring data from a plurality of sources and updating the dynamic three dimensional profile continuously to represent dynamic customer characteristics;
(b) instructions for enriching the customer profile by:
(i) value scoring a customer from a plurality of factors including at least one of a customer lifetime value, a customer lifestyle segmentation, and RFM values;
(ii) association and linking customers with at least one of family, friends and different lines of business for correlating a plurality of customer profiles;
(iii) updating the customer profile with a plurality of predictive values based on customer behaviors; and
(iv) providing an engagement modeling by correlating customer behavior and service provider interactions and transactions to provide higher success rate of interaction;
(c) instructions for mapping the acquired and enriched customer profile onto the organization offerings;
(d) instructions for delivering the next best actions (NBA) to the customer directly through relevant touch points or deploying best business actions (BBA) to provide effective business workflow within a department or an organization for enhanced customer experience; and
(e) instructions for monitoring a response by the customer and adding the response back to the customer profile to provide real-time dynamic customer feedback.

12. A computer implemented method for creating a real-time dynamic three dimensional customer profile for customers and enriching the dynamically created three dimensional customer profile, and to deploy next best actions (NBA) or best business actions (BBA) so as to enhance customer experience, the method comprising the steps of:
(a) creating a dynamic three dimensional profile for each customer by acquiring data from a plurality of sources and updating the dynamic three dimensional profile continuously to represent dynamic customer characteristics;
(b) enriching the customer profile by:
(i) value scoring a customer from a plurality of factors comprising at least one of a customer lifetime value, a customer lifestyle segmentation, and RFM values;
(ii) associating and linking the customers with at least one of family, friends, and different lines of business for correlating a plurality of customer profiles;
(iii) updating a customer profile with a plurality of predictive values based on customer behaviors; and
(iv) providing an engagement modeling by correlating customer behavior and service provider interactions and transactions to provide higher success rate of interaction;
(c) mapping the acquired and enriched customer profile onto the organization offerings;
(d) delivering the next best actions to the customer directly through relevant touch points or deploying best business actions (BBA) to provide effective business workflow within a department or an organization for enhanced customer experience; and
(e) monitoring a response by the customer and adding the response back to the customer profile to provide real-time dynamic customer feedback.

13. The computer implemented method of claim 12, wherein the three dimensional customer profile for each customer comprises customer representative characteristics comprising at least one of customer demographics, psychographics, social affinity, customer transaction profile, and customer interaction profile and updating the three dimensional customer profile continuously to provide the real time dynamic three dimensional profile for each customer.
